(19) United States
(12) Patent Application Publication
(10) Pub. No.: US 2010/0047142 A1
(43) Pub. Date: Feb. 25, 2010

(54) FILTER MEDIA INCLUDING FILTERING AGENT EFFECTIVE FOR REMOVAL OF CYANO-CONTAINING CONTAMINANTS HAVING IMPROVED COMPATIBILITY WITH AMINE SENSITIVE IMPREGNANTS AND AMINE SENSITIVE SUBSTRATES

(76) Inventors: Thomas E. Wood, Stillwater, MN (US); Zhongshu Tan, Little Canada, MN (US); Larry A. Brey, Woodbury, MN (US); Duane D. Fansler, Dresser, WI (US); John S. Huberty, St. Paul, MN (US)

Correspondence Address: 3M INNOVATIVE PROPERTIES COMPANY, PO BOX 33427, ST. PAUL, MN, 55133-3427, US

(21) Appl. No.: 12/445,773

(22) PCT Filed: Oct. 30, 2007
(86) PCT No.: PCT/US07/82921

§ 371 Date: Apr. 16, 2009

Related U.S. Application Data
(60) Provisional application No. 60/863,448, filed on Oct. 30, 2006.

(51) Int. Cl. B01D 53/86; B01J 27/24; B01J 31/02; B01J 27/232

(52) U.S. Cl. 423/210; 502/200; 502/167; 502/174

(57) ABSTRACT

Filter media containing an impregnant obtained by pre-reacting an amine functional material with a transition metal to form an amine-metal coordination complex. The complexed amine is much more compatible with amine sensitive co-impregnants or amine sensitive substrates. Additionally, even though the amine is complexed, the impregnant retains high activity for the removal of cyano-containing vapors and other contaminants for which amines have a filtering efficacy. Advantageously, therefore, the filter media may be used to remove cyano-containing vapors or other amine-targeted contaminants from air and other harmful gases in the presence of metal-based catalysts (such as those catalysts comprising platinum, gold or other active transition metals) without the undesirable effect of unduly inhibiting or poisoning the metal-based catalysts. The amine-containing coordination complex is also more compatible with substrates having electret characteristics as compared to otherwise identical amine material that is not complexed.

### FIELD

This invention pertains to filter media in which a pre-formed complex including at least an amine ligand and a species containing a transition metal is impregnated onto a substrate. The amine-containing complex is very compatible with materials that otherwise are amine sensitive.

### BACKGROUND

Extended surface area substrate particles, such as activated carbon, alumina, zeolites, and the like, are widely used in air filtration because of their ability to remove a wide range of contaminants from the air. The highly porous structure of these materials creates a high surface area media that is very suitable for filtration purposes. In the case of activated carbon, the porosity results from controlled oxidation during the “activation” stage of manufacture. Activated carbon has been used in air filtration for many decades.

The ability of the carbon to remove a contaminant from air by direct adsorption depends on a molecular-scale interaction between a gaseous molecule and the carbon surface. The extent of this interaction may depend upon factors that include the physical and chemical surface characteristics of the carbon, the molecular shape and size of the gaseous compound, the concentration of the gaseous compound in the gas stream to be filtered, residence time in the carbon bed, temperature, pressure, and the presence of other chemicals. As a rule of thumb, for a single contaminant, the extent of adsorption is primarily dependent on boiling point. In general, the higher the boiling point, the greater the capacity of carbon to remove the chemical.

Accordingly, carbon does not have a great capacity by itself for removal of lower boiling point gases or vapors from air. Treatments have been devised in which chemicals are incorporated into the carbon to provide filtering capabilities towards lower boiling gases or vapors. These treatments are generally known as “impregnation” methods, and the result of treatment is an “impregnated” carbon. Examples of impregnated carbons are described and shown in U.S. Pat. Nos. 3,436,352; 4,443,354; 4,801,311; 5,113,856; and 5,344,626.

Over the course of this century, activated carbon impregnation has progressed so that a variety of impregnants are available for removing a wide range of different contaminants from air and other gases. There has been a general distinction between the types of filter media particles used for military applications, and those used in industrial applications. Military requirements have made it necessary for filter media particles to be capable of removing a range of chemicals, and so multi-component impregnation formulations have been devised. In industry, where the nature of hazards is known in advance, the practice has been to select a filter appropriate to the known hazard. Consequently, filters with capability toward a specific type of chemical or class of chemicals have developed for industrial applications.

Over time, regulatory structures for the selection and use of respiratory protective equipment have evolved, along with approvals systems to ensure that designs of equipment on the market are capable of meeting necessary performance requirements. Such approvals systems have been generated for industrial purposes across international boundaries. These include the European Norm system that is adopted widely in Europe and elsewhere in the world. Another example is the US National Institute for Occupational Safety and Health approvals requirements that have been adopted in the USA, Canada, and other countries. For military requirements, performance specifications are determined by each national need, although there are some internationally agreed upon standards under the North Atlantic Treaty Organization.

An early U.S. patent for carbon treatment arose from developments to protect personnel operating in World War I battles. The patent by Joshua C. Whetzel and R. E. Wilson (U.S. Pat. No. 1,519,470, 1924) described the use of copper salts with subsequent decomposition to the metal or oxide to impregnate a granular activated carbon. This technique became known as “Whetlerization”, and the carbon product “Whetlerite”. Variations on this technique have been developed over time—see, for example, the following patents: U.S. Pat. No. 2,920,050, U.S. Pat. No. 2,920,051, DE 1,098,579, FR 1,605,363, JP 7384,984, and CZ 149,995.

During World War II, substantial technical investigations were made into the use of impregnated carbons. The U.S. research in this area is summarized in “Military Problems with Aerosols and Nonpersistent Gases”, Chapter 4: “Impregnation of Charcoal”, by Grabenstetter, R. J., and Blacet, F. E., Division 10 Report of US National Defense Research Committee (1946) pp. 40-87. This report provides in depth coverage of a number of impregnant formulations.

The United Kingdom pursued a slightly different impregnation approach whereby copper oxide was mixed with coal prior to carbonization and activation, so that the activated carbon contained metallic copper distributed throughout its structure. This material was the basis for the UK filter carbons of World War II.

The ability of the carbon to remove cyanogen chloride (CK) was improved by the application of the amine pyridine or, separately, by impregnation with hexavalent chromium. This form of carbon, in combination with a pyridine impregnant, was used in some military respirator filters manufactured in the 1970s. Because the hexavalent ionic form of chromium has been identified as a potential lung carcinogen, work undertaken in recent times, and dating back to the early 1970's, has explored formulations that avoid or reduce the level of chromate salts as impregnants.

In the meantime, more recent research has explored how the addition of organic compounds to impregnated carbon could minimize the loss of activity against cyanogen chloride observed after wet aging. Experiments were undertaken in the United States, the UK, France, and elsewhere with various amines. One such material found to improve wet aging performance towards cyanogen chloride is triethylenediamine (also known by other names such as TEDA, DABCO, or 1,4-diazabicyclo-2,2,2-octane). When impregnated on carbon, TEDA is highly nucleophilic and has been found in its own right to be capable of protecting against cyanogen chloride. Theories suggest that the TEDA might react directly with the cyanogen chloride and/or catalyze the hydrolysis of the cyanogen chloride. TEDA is also very effective for removing methyl bromide and methyl iodide from air and other gases. TEDA is strongly adsorbed onto carbon, is stable, and is effective at low levels. TEDA is a solid at room temperature, but sublimes readily.

In recent times, the traditional role of military forces has changed from a more or less predictable battlefield conflict to encompass peace-making and peace-keeping roles, and supporting civilian authorities in emergency response. Such activities may involve responding to the release of chemicals by accident or intent. These incidents may involve chemicals that have been traditionally regarded as military threats or may involve hazardous chemicals normally used in industry. The response to these hazards is ultimately likely to involve both civilian and military authorities and is likely to require protection systems that meet industrial approvals as well as military performance requirements.

Filtration-based protection systems are appropriate for personnel undertaking various tasks at some distance from a point of chemical release. For such cases, it is most desirable to be able to respond to a hazard quickly and without delay. Conventionally, however, delay may be inevitable as it may be necessary to first identify a threat in order to select an appropriate filter. In order to be able to respond to a wide range of possible hazards, it has been necessary to carry inventories of many different kinds of filters. It would be much more desirable to have one filter type that can provide protection against many different hazards. Such a multi-purpose filter desirably would accommodate both industrial and military needs.

Additionally, there has long existed a need for protection against the toxic combustion or other harmful products generated by fires in building, mining, vehicle, industrial, civilian, military, maritime and aerospace settings. Carbon monoxide, in particular, is a toxic gas formed by incomplete burning of organic materials. Carbon monoxide combines with blood hemoglobin to form carboxyhemoglobin which is ineffective at transporting oxygen to body cells. Inhalation of air containing 1-2% (10,000 to 20,000 parts-per-million (ppm)) CO by volume will cause death within several minutes. CO concentrations higher than 1200 ppm are considered immediately dangerous to life and health by the U.S. National Institute of Occupational Safety and Health (NIOSH).

CO is responsible for many fire fatalities. It is also encountered in mining operations in which explosives are used in confined spaces or in which miners are trapped in enclosed spaces without a fresh air supply. CO is also present in the exhausts of gasoline or diesel powered internal combustion engines. Poorly operating engines, machinery, heating equipment, ventilation equipment, air conditioning equipment, and other equipment may also output CO, contaminating the air in buildings and vehicles. Consequently, there is a strong need for protection against CO in these and other environments in which persons may encounter the gas.

Firefighters and other emergency response personnel have been equipped with self-contained respirators using compressed air or oxygen in cylinders to provide protection against CO. These devices tend to be heavy, bulky, expensive, and require special training for effective use. It generally is not feasible to equip everyone in an area with such devices.

A fire or other sudden unexpected release of carbon monoxide in a building, public place, vehicle, or the like may require that individuals quickly escape from an area containing dangerous concentrations of the gas. In these situations, an easy-to-use, lightweight respirator or mask equipped with media that is capable of protecting against carbon monoxide can be desirable.

Protection against CO is also beneficial in the cabin environment of a car, truck, rail-borne vehicle, marine vessel, or other transportation vessel. In many heavily congested traffic areas and in tunnels, elevated CO levels can develop from the accumulation of exhaust emissions. Typically, the CO levels encountered are usually less than 200 to 300 ppm, but even these CO levels can cause headaches, dizziness, and nausea to drivers and passengers. Large gas volumes and high flow rates through the vehicle filter are needed to provide clean air to the vehicle inhabitants. In view of these throughputs, the residence time of the cabin air intake on the filter catalyst is short, typically being less than 0.05 seconds and even less than 0.03 seconds. It is therefore desirable to have a filter system that also can remove CO under these conditions.

The low boiling point and high critical temperature of CO make its removal by physical adsorption particularly difficult when the CO is present at room temperature. Conventional gas mask canisters and filters based on activated carbon adsorbents have been relatively useless as a practical matter against carbon monoxide.

Catalytic oxidation to carbon dioxide is one feasible method for removing carbon monoxide from air at the high concentrations and flow rates required for individual respiratory protection. Most CO oxidation catalysts, however, are only active at temperatures of 150° C. or higher. This is true even though oxidation to CO₂ is thermodynamically favored. Very few CO oxidation catalysts are active at room temperature or below. A catalyst useful for respiratory protection against CO desirably functions at low temperatures.

It has been observed that nanoislands of very finely divided gold on reducible oxide supports are very active for CO oxidation at low temperature. At ambient to sub-ambient temperatures, the best gold catalysts are considerably more active for CO oxidation than the most active promoted platinum group metal catalyst known. Gold is also considerably cheaper than platinum. Catalytically active gold, though, is quite different from the platinum group metal catalysts that have been more widely used commercially. The standard techniques used in preparing supported platinum group metal catalysts give inactive CO oxidation catalysts when applied to gold. Different techniques, therefore, have been developed for depositing finely divided gold on supports. Even so, highly active gold catalysts have been difficult to prepare reproducibly. Scaleup from small lab preparations to larger batches has also proved difficult.

These technical challenges have hindered the industrial application of gold catalysts. This is unfortunate since the high activities of gold catalysts for CO oxidation at ambient and sub-ambient temperatures and their tolerance for high water vapor concentrations make them otherwise strong candidates for use in respiratory protection filters and in other applications in which CO oxidation is desired.

Heterogeneous catalyst systems and related methodologies that use catalytically active gold have been described in the assignee's co-pending United States Patent Application having U.S. Ser. No. 10/948,012, bearing Attorney Docket No. 58905US003, titled CATALYSTS, ACTIVATING AGENTS, SUPPORT MEDIA, AND RELATED METHODOLOGIES USEFUL FOR MAKING CATALYST SYSTEMS ESPECIALLY WHEN THE CATALYST IS DEPOSITED ONTO THE SUPPORT MEDIA USING PHYSICAL VAPOR DEPOSITION in the names of Larry Brey et al., and filed Sep. 23, 2004, the entirety of which is incorporated herein by reference for all purposes. In particular, this co-pending application describes providing catalytically active gold on a composite support derived from relatively fine titania particles (referred to as guest material) that at least partially coat the surfaces of relatively large alumina particles (referred to as host material). These composite systems provide excellent catalytic performance with respect to CO oxidation. It is also desirable to use such catalysts in respiratory protection systems that provide protection against not only CO but other airborne contaminants as well.

Gold catalyst systems are described in Assignee's co-pending applications U.S. Ser. No. 10/948,012, filed Sep. 23, 2004, by Brey et al., titled CATALYSTS, ACTIVATING AGENTS, SUPPORT MEDIA, AND RELATED METHODOLOGIES USEFUL FOR MAKING CATALYST SYSTEMS ESPECIALLY WHEN THE CATALYST IS DEPOSITED ONTO THE SUPPORT MEDIA USING PHYSICAL VAPOR DEPOSITION; U.S. Ser. No. 11/275,416, filed Dec. 30, 2005, by Brady et al., titled HETEROGENEOUS, COMPOSITE, CARBONACEOUS CATALYST SYSTEM AND METHODS THAT USE CATALYTICALLY ACTIVE GOLD; U.S. Provisional Application Ser. No. 60/777,859, filed Feb. 28, 2006, by Thomas I. Insley, titled LOW PRESSURE DROP, HIGHLY ACTIVE CATALYST SYSTEMS USING CATALYTICALLY ACTIVE GOLD; U.S. Provisional Application Ser. No. 60/778,663, filed Mar. 2, 2006, by Thomas I. Insley, titled LOW PRESSURE DROP, HIGHLY ACTIVE CATALYST SYSTEMS USING CATALYTICALLY ACTIVE GOLD; U.S. Provisional Application Ser. No. 60/773,866, filed Feb. 15, 2006, by Larry A. Brey, titled SELECTIVE OXIDATION OF CARBON MONOXIDE RELATIVE TO HYDROGEN USING CATALYTICALLY ACTIVE GOLD; and U.S. Provisional Application Ser. No. 60/774,045, filed Feb. 15, 2006, by Larry A. Brey, titled CATALYTICALLY ACTIVE GOLD SUPPORTED ON THERMALLY TREATED NANOPOROUS SUPPORTS, the respective entireties of which are incorporated herein by reference for all purposes.

It would be highly desirable to provide filter systems that include both catalytically active metals, especially gold, on a support as well as other filter media impregnated with amines. For instance, if a filter system were to include both an amine impregnated filter medium and catalytically active gold on a support, that filter system could protect against not only cyano-containing gases and the like, but against CO as well. Unfortunately, amines such as triethylenediamine, or “TEDA”, are very potent poisons for the metal-based catalysts. TEDA has been found to significantly degrade catalyst function when carbon beds containing TEDA were aged in the presence of the CO oxidation catalyst. Further, TEDA also has been shown to dramatically lower the filtration efficiency of high performance electret filter materials. Thus, it has become very important to develop an agent that would effectively protect against cyanogen chloride and the like without degrading amine-sensitive components of the filter system.

### SUMMARY OF THE INVENTION

The present invention relates to filter media that contains an impregnant obtained by pre-reacting an amine functional material with a transition metal to form an amine-metal coordination complex. The pre-formed complex is then impregnated onto one or more desired supporting substrates. The complexed amine is much more compatible with amine sensitive components that might also be present in the filter system. Advantageously, therefore, the filter media may be used to remove cyano-containing vapors or other amine-targeted contaminants from air in the presence of metal-based catalysts (such as those catalysts comprising platinum, gold or active transition metals) without unduly inhibiting or poisoning the metal-based catalysts. In some embodiments, the moisture content of the filter system may be minimized to further protect the efficacy of the catalyst(s) that might be present in the filter system. The amine-containing coordination complex is also more compatible with electret filter media as compared to otherwise identical amine material that is not complexed.

Additionally, even though the amine functionality serves as coordination site(s) for complexation with the transition metal, the impregnant retains high activity for the removal of cyano-containing vapors and other contaminants for which amines have a filtering efficacy. The activity of the complexed amine can be enhanced by contacting the substrate with a base (e.g., a hydroxide or a carbonate, or the like). The base treatment desirably may occur prior to impregnation of the pre-formed complex.

These materials allow the creation of filtering systems capable of removing CO gas as well as hydrogen cyanide, cyanogen chloride, methyl bromide, methyl iodide, and the like, while retaining long storage life and thermal durability. These materials would find use in the creation of filtering media for use in a smoke hood or an escape hood. These materials can also be used in both collective and personal protection.

In one aspect, the present invention relates to a method of forming a filter medium. A reaction product of an amine functional material and a species comprising a transition metal is provided. At least one base is caused to contact a substrate. After contacting the substrate with the at least one base, the reaction product is impregnated onto the substrate. In another aspect, the present invention relates to a method of using the resultant filter medium to filter a fluid stream.

In another aspect, the present invention relates to a filter system. The system includes a first filter medium comprising an impregnant derived from ingredients comprising an amine complex. The system also includes a second filter medium comprising a catalyst.

### GLOSSARY

The terms set forth below are defined to have the following meanings:

The term “amine functional material” means a material comprising at least one nitrogen that possesses a lone pair of electrons. More preferably, the term “amine functional material” means an organic material comprising a nitrogen bound to three moieties, wherein at least one of the moieties is not hydrogen. More than one of such moieties bound to the nitrogen may be co-members of a ring structure.

The term “base” means any material, e.g., any molecular or ionic substance, that can combine with a proton (e.g., a hydrogen ion) to form a new compound. Water soluble bases yield a pH in the range of 7.1 to 14 in aqueous solution. The term “filter medium” means a fluid, e.g., air, permeable structure that is capable of removing at least one contaminant from a fluid that passes through it.

The term “filtering efficacy”, with respect to an impregnant generally, means that a filter medium incorporating the impregnant has a greater capacity to remove a designated contaminant from a gas composition as compared to otherwise identical media that lack the impregnant. In preferred embodiments, filtering efficacy means that the impregnant is able to provide filtering protection against a designated contaminant in accordance with a desired governmental regulation, such as NIOSH standards in the United States and/or CEN standards in Europe. An impregnant may have such a filtering efficacy either by itself and/or when used in combination with one or more other impregnant(s).

The term “impregnating” means causing a material to be physically, chemically, and/or ionically provided on and/or within a solid or semi-solid. In preferred embodiments, impregnation involves contacting a porous and/or textured solid with a fluid in such a manner so as to enable the fluid to penetrate the pores of the solid and/or to coat the surface of the solid.

The term “reaction product” means the primary chemical compounds produced by causing direct contact and intimate mixing of the amine functional material and the transition metal salt and further comprising at least a portion of the transition metal after the reaction with the amine functional material.

The term “species” means a chemically distinct atom, ion molecule, radical, or other compound.

The term “substrate” means a solid or semi-solid, commonly a solid particle or granule, that is used to support at least one chemical agent used to help purify a fluid stream. It is preferred that the substrate also comprises pores and/or a surface texture to enhance the surface area characteristics of the solid.

The term “transition metal” means a metal selected from the transition metals of the periodic table including cobalt, copper, zinc, tungsten, molybdenum, silver, nickel, manganese, iron, combinations of these, and the like.

### BRIEF DESCRIPTION OF THE DRAWINGS

FIG. 1 is a graph that shows the ability of filter media samples to protect against cyanogen chloride when tested using the test procedure (described below).

FIG. 2 is a graph that shows the ability of filter media samples to protect against cyanogen chloride after thermal aging when tested using the test procedure 1 (described below).

FIG. 3. is a graph that shows the ability of a CO oxidation catalyst to catalyze CO after thermal aging with filter media samples.

FIG. 4 is a graph that shows the ability of filter media samples to protect against cyanogen chloride in which the method of impregnation of an amine-metal complex onto a substrate is varied and using the test procedure 1 (described below).

FIG. 5 is a graph that shows the ability of filter media samples to protect against cyanogen chloride in which different portions of an aqueous reaction mixture of an amine and a transition metal are used as the impregnant and when using the test procedure 1 (described below).

FIG. 6 is a graph that shows the ability of filter media samples to protect against cyanogen chloride when tested using the test procedure 1 (described below).

FIG. 7 is a schematic view, partially in cross-section, of an exemplary replaceable filter element of the present invention incorporating principles of the present invention.

FIG. 8 is a perspective view of an exemplary respiratory device for personal protection that uses the filter element of FIG. 7.

### DETAILED DESCRIPTION OF PRESENTLY PREFERRED EMBODIMENTS

The embodiments of the present invention described below are not intended to be exhaustive or to limit the invention to the precise forms disclosed in the following detailed description. Rather the embodiments are chosen and described so that others skilled in the art may appreciate and understand the principles and practices of the present invention.

A filter system of the present invention generally includes at least a first filter medium containing an amine complex supported on a first substrate and optionally at least one additional filter medium. In those embodiments including at least one optional, additional filter medium, any such additional filter medium may differ from the first filter medium in one or more respects. For instance, the additional filter medium may comprise a different substrate, one or more different filtering agents, and/or one or more different activating agents or treatments as compared to the first filter medium. When the filter system includes a first filter medium and at least one additional filter medium, the different filter media may be intermingled in the same filter bed and/or provided in different filter beds. If the media are presented in different beds, these may be provided in a variety of manners such as by being sequential or parallel with respect to the flow of air or other gas flowing through the system.

In more detail, the first filter medium of the present invention generally includes an amine complex incorporated into or onto a substrate. In representative embodiments, the substrate is in the form of an extended surface area substrate that is impregnated with, or otherwise treated to incorporate, a coordination complex comprising one or more ligands coordinated to a species comprising a transition metal, wherein at least one of the ligand(s) is an amine functional material.

Although some of the coordination complex may be formed on the substrate in situ, at least a portion of the coordination complex is pre-formed and then impregnated into the substrate. Introducing the amine functional material onto the substrate as a constituent of a pre-formed coordination complex advantageously dramatically lowers the poisoning effect that the amine per se might otherwise have had upon metal catalysts present in the filter system such as if such catalysts were to be present on the same substrate or on another substrate in admixture with, upstream from, downstream from, or in parallel with the substrate bearing the amine-containing complex. The amine-containing coordination complex is also more compatible with electret media when the complex is pre-formed.

For example, while complexation of TEDA with a metal salt can occur in situ to a certain extent by addition of the TEDA to a substrate that has been pre-impregnated with the metal salt, the in situ process does not complex as much of the TEDA as might be desired. Consequently, too much TEDA on the substrate may tend to be non-complexed. This TEDA is free to desorb to poison or otherwise damage the activity of amine-sensitive impregnants and/or amine-sensitive substrates. In the practice of the present invention, the most stable and active systems involve TEDA that has been complexed essentially in total with a metal containing species, with any free TEDA being driven off or otherwise removed or consumed. We have found that this is most readily achieved by pre-reaction of an excess of TEDA with the metal salt prior to impregnation. After impregnation of the TEDA complex onto the substrate, any unreacted TEDA is driven off by a suitable technique such as a thermal treatment or the like.

Surprisingly, providing the amine in the form of a pre-formed complex not only dramatically improves compatibility with other materials, but the activity of the complexed amine towards removal of cyano-containing gases after complexation is maintained to a significant degree. In addition to protecting against cyano-containing gases, the complexed amine would also provide effective protection against other gases including methyl iodide, methyl bromide, and the like.

In some embodiments, such as those including a complexed TEDA, the activity of the complexed amine is even increased relative to the uncomplexed amine. This increase in activity is unexpected since the TEDA, being di-amine functional, would be expected to lose the reactivity of at least one of the amine groups as one or both of the amine moieties would function as a coordination site with the metal. Thus, a loss of activity of the coordinated amine moieties would be expected to result from complexation of the amine with the metal through the lone pair of electrons on the amine nitrogen. Thus, by forming the complex, at least half of the nucleophilic lone pairs of electrons of the amine, which are the features of the TEDA that are believed to give rise to the ability of the TEDA to protect against cyanogen chloride and other contaminants, are involved in the coordination. Yet, in representative embodiments, we have found that coordination complexes formed from TEDA and copper, zinc, and cobalt, respectively, remain highly active as agents to protect against cyanogen chloride and show enhanced compatibility with supported metal catalysts and electret substrates. The activity of the TEDA complex is also improved when the substrate bearing the TEDA complex is treated with a base, preferably prior to impregnation.

It is our belief that the enhanced compatibility of the complexed amines arises at least partially as a result of a lowering of the TEDA volatility via complexation. An important characteristic of the first filter medium is that the amount of volatile, free TEDA (i.e., TEDA that is not complexed) in these materials is very low. The amount of volatile, free TEDA can be measured gravimetrically by measuring the weight loss after heating the sample in air at 130° C. for 5 hours and calculating the amount of the weight loss due to the loss of TEDA. The materials of the present invention exhibit less than a 2% weight loss of total TEDA and often less than 1% weight loss of total TEDA under these conditions. Because water can be lost along with TEDA in this experiment, the percent of weight loss due to loss of TEDA in this experiment is determined by analyzing the content of TEDA in the materials that is lost by vaporization by trapping the material on a cold finger, e.g., one cooled with cold water (<10° C. water) in a closed vessel wherein the portion of the vessel containing the TEDA-metal complex-support material is heated to 130° C. while keeping the cold finger in close proximity to the sample and keeping the cold finger at <10° C. during the experiment. The percent of TEDA in the material trapped on the cold finger can be analyzed by standard analytical procedures to determine the percent of the weight loss that is due to the loss of TEDA. This percent is then multiplied by the total weight loss in the gravimetric experiment to determine the weight loss that is due to loss of TEDA. The percent of the total TEDA that is lost in this treatment is then calculated by dividing the weight loss due to the loss of TEDA by the total weight of the TEDA that is in the sample that is being evaluated.

A wide variety of amine functional impregnants may be beneficially incorporated into the coordination complex, either singly, or in combination. Suitable amines may be primary, secondary, or tertiary. Secondary or tertiary amines tend to provide better protection against species such as methyl iodide. Preferred amines are either a solid or liquid at room temperature, i.e, about 25° C., at 1 atm. Preferred amines have a filtering efficacy against CK, methyl bromide, and/or methyl iodide. Representative examples of suitable amines include amines such as triethylamine (TEA) or quinuclidine (QUIN); diamines such as triethylenediamine (TEDA); pyridine, pyridine carboxylic acids such as pyridine-4-carboxylic acid (P4CA), combinations of these, and the like. Of these, TEDA is preferred.

A wide range of species comprising a transition metal, or combinations of transition metals, may be coordinated to the amine ligand(s) in the practice of the present invention. Representative examples of suitable transition metals include cobalt, copper, zinc, tungsten, molybdenum, silver, nickel, manganese, iron, combinations of these and the like. Many of these transition metals have filtering efficacies themselves, and therefore serve double duty as not only part of the coordination shell but also as filtering agents.

In addition to the amine complex included in the first filter medium, one or more additional filtering agents may also be used in the first filter medium and/or in one or more additional filter media that might be used in the filter system. Because of the enhanced compatibility characteristics of the complexed amine, preferred embodiments of optional additional filtering agents may include one or more catalysts. Examples of such catalysts include metal catalysts such as platinum, silver, gold, nickel, palladium, rhodium, ruthenium, osmium, copper, iridium, combinations of these, and the like.

Catalytically active gold is a preferred catalyst component of the filtering system. Conventionally, gold catalysts are extremely amine sensitive inasmuch as amines tend to poison the catalytic activity of gold. Since the poisoning can be caused by the adsorption of gas phase amines, this poisoning effect tends to occur regardless of whether the amine and the gold are on the same or different substrates incorporated into a system. However, gold is dramatically less sensitive to complexed amine, and therefore the two materials are quite functional in the same filtering system. Accordingly, preferred filtering systems of the present invention include complexed amine and a catalyst such as catalytically active gold. Such preferred embodiments of the invention incorporate the metal catalysts onto an optional, second filter medium in which the catalyst is supported upon a suitable substrate. Such second filter media may be intermingled with, or provided in a separate filter bed from, the first filter medium including the amine complex. By way of example, one suitable embodiment of the invention provides the second filter medium in a separate filter bed that is upstream from a filter bed that includes the first filter medium. To help favor the catalytic activity of the gold, the substrate supporting the gold desirably is nanoporous, and the gold is deposited onto the substrate using physical vapor deposition techniques as described in Assignee's co-pending applications cited herein, all of which are incorporated herein by reference in their respective entireties for all purposes.

A wide variety of other filtering agents also may be useful impregnants in a filtering system of the present invention. These additional filtering agents may be incorporated into the first filtering medium including the amine complex and/or on one or more additional, optional filtering media. Examples of these other filtering agents include one or more metals, metal alloys, intermetallic compositions, and/or compounds containing one or more of Cu, Zn, Mo, Cr, Ag, Ni, V, W, Y, Co, combinations thereof, and the like. However, because the hexavalent form of Cr has been identified as a potential carcinogen, the catalyst system of the present invention preferably includes no detectable amounts of Cr (VI), and more preferably no detectable Cr of any valence state due to the risk that other forms of Cr, e.g., Cr(IV) could be oxidized to Cr(VI). The metals typically are impregnated as salts and can be converted to other forms, e.g., oxides perhaps, during some modes of impregnation. Advantageously, the presence of these transition metals can also help to form complexes with free amine that might be present as a consequence of using excess amine to form the coordination complex impregnant.

The selection of which one or more transition metal compounds to incorporate into the filter system depends upon the desired range of filtering capabilities inasmuch as each of the various transition metals tend to provide protection against particular air contaminants. For example, Cr, Mo, V, and Y or W independently help to filter gases such as cyanogen chloride and hydrogen cyanide from air streams when used in combination with a Cu impregnant. Representative catalyst system particles may include 0.1 to 10 weight percent of one or more impregnants including Mo, V, W, and/or Cr. Due to the potential toxicity of Cr, the use of Mo, V, and/or W materials are preferred. Throughout this specification and accompanying claims, weight percent with respect to impregnants is based upon the total weight of the impregnated particles unless otherwise noted.

Cu tends to help filter many gases such as HCN, H₂S, acid gases, and the like from air streams. Representative filter media particles may include 0.1 to 15 weight percent of one or more impregnants including Cu.

Zn in various forms tends to help filter HCN, cyanogen chloride, cyanogen, and NH₃ from air streams. Representative filter media particles of the present invention may include 1 to 20 weight percent of one or more impregnants including Zn.

Ag tends to help filter arsenical gases from an air stream. Ag functions catalytically and generally is not consumed during filtering operations. Accordingly, filter media particles may include relatively small catalytic amounts, e.g., about 0.01 to 1, preferably 0.1 weight percent, of one or more Ag-containing impregnants.

Ni and Co each independently help to filter HCN and NH₃ from air streams. Representative filter media particles may include 0.1 to 15 weight percent of one or more Ni containing impregnants and/or Co containing impregnants.

In addition to one or more filtering agents that contain transition metals, other kinds of filtering agents also may be used as impregnants in the first filtering medium and/or one or more additional, optional filtering media of the present invention. For example, ammonia or ammonium salts in the impregnating solution not only help to improve the solubility of transition metal compounds during the manufacture of a filter system, but remaining adsorbed quantities also help to remove acid gases from air or gas streams. Sulfate salts are believed to help to control the pH during usage of filter media. Ammonium sulfate, for instance, when impregnated on a substrate such as carbon and dried at 145° C. forms an acid sulfate. Acid sulfate is sufficiently acidic to react with ammonia to facilitate removal of ammonia from a flow of air or other gas. Through impregnation and drying, strongly acidic ammonium salts impregnate the carbon during the drying process without damaging the basic oxide/hydroxide impregnant being formed. This results in enhanced ammonia service life of a cartridge containing the resultant impregnated carbon. Representative filter media particles may include 0.1 to 10, preferably 2.5 to 4.5 weight percent of sulfate.

Water may or may not be a desired impregnant of the filter system among the various aspects of the invention. For instance, in those embodiments including a metal catalyst, particularly catalytically active gold, moisture can impair the activity of the catalyst. Consequently, it is desirable to minimize the amount of water that is present in the filter system in those embodiments that include a metal catalyst. In such embodiments, it is preferred that the filter system include less than 2 parts by weight, more preferably less than about 1 part by weight of water per 100 parts by weight of filter media included in the system.

Yet, moisture beneficially helps to remove acid gases from air streams. Consequently, in those embodiments of the invention that do not include a metal catalyst, the filter system may include up to about 15 weight percent, preferably about 2 to 12 weight percent of water per 100 parts by weight of filter media included in the filter system.

Glycols are known to provide a filtering efficacy similar to water. Accordingly, in those embodiments that include a metal catalyst and for which the water content is desirably minimized, the filter system may further include one or more glycols such as ethylene glycol, propylene glycol, combinations of these, and the like. Generally, using from about 0.1 to about 25 parts by weight, preferably 0.1 to 10 parts by weight, of one or more glycols per 100 parts by weight of substrate supporting the glycol would be suitable.

A wide variety of substrates may be independently used in the first filter medium and the optional one or more additional filter media, if any. Preferred substrates have an extended surface are in which the surface is sufficiently convoluted, textured, and/or porous such that the substrate is capable of being impregnated with at least about 0.5%, preferably at least about 3%, more preferably at least about 5% or more by weight of one or more impregnants including at least the amine-containing coordination complexes described herein in the case of the first filtering medium.

The substrate(s) used in the first and/or any additional filter media independently may have any of a wide range of forms. Examples include woven or nonwoven fabric; bonded, fused, or sintered block; extended surface area particles; filtration media arrays such as those described in U.S. Pat. No. 6,752,889 and Assignee's co-pending U.S. Provisional Patent Applications titled LOW PRESSURE DROP, HIGHLY ACTIVE CATALYST SYSTEMS USING CATALYTICALLY ACTIVE GOLD in the name Thomas Insley, filed Mar. 2, 2006 and having U.S. Provisional Application Ser. No. 60/778,663; and U.S. Provisional Application Ser. No. 60/778,663, filed Mar. 2, 2006, by Thomas I. Insley, entitled LOW PRESSURE DROP, HIGHLY ACTIVE CATALYST SYSTEMS USING CATALYTICALLY ACTIVE GOLD (the respective entireties of which are incorporated herein by reference for all purposes) or as commercially available under the trade designation 3M High Air Flow (HAF) filters from 3M Company, St. Paul, Minn.; combinations of these; and/or the like.

Substrates in the form of particles are preferred. Suitable extended surface area particles tend to have BET specific surface areas of at least about 85 m²/g, more typically at least about 300 m²/g to 2000 m²/g, and preferably about 900 m²/g to about 1500 m²/g. In the practice of the present invention, BET specific surface area of particles may be determined by the procedure described in ISO 9277:1995, incorporated herein by reference in its entirety.

In some embodiments, substrate particles may have a guest/host structure in which relatively fine guest media is supported upon a larger host structure. In one representative approach, an extended area substrate is made by adsorbing or adhering fine guest particles onto larger host material such as coarser particles, fibers, honeycomb material, combinations of these, and the like. Substrates in the form of particles having a guest/host structure as described in Assignee's co-pending patent applications U.S. Ser. No. 10/948,012, filed Sep. 23, 2004, by Brey et al., titled CATALYSTS, ACTIVATING AGENTS, SUPPORT MEDIA, AND RELATED METHODOLOGIES USEFUL FOR MAKING CATALYST SYSTEMS ESPECIALLY WHEN THE CATALYST IS DEPOSITED ONTO THE SUPPORT MEDIA USING PHYSICAL VAPOR DEPOSITION; U.S. Ser. No. 11/275,416, filed Dec. 30, 2005, by Brady et al., titled HETEROGENEOUS, COMPOSITE, CARBONACEOUS CATALYST SYSTEM AND METHODS THAT USE CATALYTICALLY ACTIVE GOLD; U.S. Provisional Application Ser. No. 60/773,866, filed Feb. 15, 2006, by Larry A. Brey, entitled SELECTIVE OXIDATION OF CARBON MONOXIDE RELATIVE TO HYDROGEN USING CATALYTICALLY ACTIVE GOLD, the respective entireties of which are incorporated herein by reference for all purposes.

Examples of nonparticulate host material include woven and nonwoven media, membranes, fibers, plates, filtration media arrays such as those described in U.S. Pat. No. 6,752,889 889; Assignee's co-pending U.S. Provisional Patent Application Ser. No. 60/777,859, filed Feb. 28, 2006, by Thomas I. Insley, titled LOW PRESSURE DROP, HIGHLY ACTIVE CATALYST SYSTEMS USING CATALYTICALLY ACTIVE GOLD; U.S. Provisional Application Ser. No. 60/778,663, filed Mar. 2, 2006, by Thomas I. Insley, titled LOW PRESSURE DROP, HIGHLY ACTIVE CATALYST SYSTEMS USING CATALYTICALLY ACTIVE GOLD; or as commercially available under the trade designation 3M High Air Flow (HAF) filters from 3M Company, St. Paul, Minn. These media generally include a plurality of open pathways, or flow channels, extending from one side of the media to the other. Preferably, the arrays have electret characteristics that help hold the particulate media onto the surfaces of the channels. Even though the impregnated particles might only coat the surfaces of these channels, leaving large open volumes through the channels for air streams to pass, it is expected that air streams passing through the arrays nonetheless would be filtered with virtually no pressure drop.

Substrates useful in the first and or any additional filter media independently may be made from a wide variety of materials in the practice of the present invention. Representative examples include paper, wood, polymers and other synthetic materials, carbonaceous materials, silicaceous materials (such as silica), metals, compounds of metals, combinations of these, and the like.

Representative metal oxides (or sulfides or nitrides) include oxides (or sulfides or nitrides) of one or more of magnesium, aluminum, titanium, vanadium, chromium, manganese, cobalt, nickel, copper, zinc, gallium, germanium, strontium, yttrium, zirconium, niobium, molybdenum, technetium, ruthenium, rhodium, palladium, silver, cadmium, indium, iron, tin, antimony, barium, lanthanum, hafnium, thallium, tungsten, rhenium, osmium, iridium, and platinum. Examples of carbonaceous substances include activated carbon and graphite. Suitable activated carbon particles may be derived from a wide variety of source(s) including coal, coconut, peat, any activated carbon(s) from any source(s), combinations of at least two of these, and/or the like.

One or more constituents of the first and/or any additional filtering media used in a filter system optionally may be subjected to one or more treatments that enhance the performance of one or more aspects of the system. As one example, it is highly beneficial to activate the substrate used to support the amine complex with at least one base to enhance the filtering efficacy of the amine complex against cyanogen chloride. While the substrate may be activated with the base(s) before, during, and/or after impregnation of the amine complex onto the substrate, it is preferred to activate the substrate with the base(s) first. A wide variety of one or more bases may be used to activate the substrate used in the first filter medium. Examples of suitable bases include hydroxide and carbonate bases such as KOH, NaOH, Ba(OH)₂, Li(OH), K₂CO₃, NaHCO₃, Na₂CO₃, alkali-metal carboxylate salts such as potassium acetate and sodium acetate, combinations of these, and the like. Of these potassium acetate (KO₂C₂H₃), NaHCO₃, KOH and K₂CO₃ are preferred.

The presence of a base in the porous medium provides enhanced activity of the amine-transition metal complex, e.g., a transition metal-TEDA complex, for removal of cyano-containing contaminants. This enhanced activity is evidenced by a lengthening of the time to breakthrough of a cyano-containing contaminant, e.g., cyanogen chloride, as measured for a sample containing the amine-transition metal complex in combination with a base as compared to a sample containing an identical amount of the amine-transition metal complex but without the added base. Thus, the amount of cyano-containing contaminant that can be removed per amine-transition metal complex is increased by combination with a base.

In general, the substrate is activated by the chosen base via an impregnation process. This process involves contacting the substrate with a solution containing the basic compound in such a manner as to wet and penetrate the pores of the substrate with the base solution. It is desirable for the substrate to be wetted as uniformly as possible in this process so as to uniformly distribute the base onto and into the substrate for activation. This wetting process can involve complete immersion of the substrate in the base solution followed by separation of the wetted substrate from the base solution by filtration or it can involve an incipient wetness process so that a minimum of base solution is used and all of the solution is transferred onto and into the substrate surface and pores.

While enhanced activity can be seen by impregnating the substrate with a low concentration of base, e.g., 0.1 M base solution or even more dilute, a desirable effect is developed when the base is impregnated at a strength of 1M or higher. Generally, raising the concentration of the base above 1M provides little additional enhanced activity over the samples impregnated with 1M base in many embodiments. So, in most cases it is preferred to impregnate with a base solution at a concentration of 0.75M to about 1.25 M.

After impregnation of the substrate with the base solution, the substrate is dried to remove the carrier liquid and to deposit the base on the surface and in the pores of the substrate.

When impregnated onto the substrate particles, the initial form of any of the impregnant(s) may or may not be chemically altered during the course of fabrication. For instance, if the fabrication process involves a thermal drying treatment after solution impregnation, one or more of the impregnants may be chemically converted into other compounds. For instance, some or all of a copper salt may be converted to a copper oxide, a copper hydroxide, a copper carbonate, or metallic copper, or other copper compound as a consequence of thermal treatment. As another example, ammonium sulfate salt advantageously is believed to be converted into ammonium bisulfate in situ, helping to provide filtering protection against basic contaminants such as ammonia.

A variety of techniques may be used for preparing and then impregnating the pre-formed, complexed amine and other co-impregnants or agents (if any) onto extended surface area substrates. These include, for example, solution impregnation, spraying, a fluidized bed method (Ro et. al, U.S. Pat. No. 5,792,720), and a low pressure sublimation method (Liang et. al. U.S. Pat. No. 5,145,820). Because of the low volatility of the complex, fluid impregnation techniques such as solution impregnation or spraying are often more practical. Any conventional solution impregnation method may be used. When other impregnants are to be co-impregnated onto the substrate using solution impregnation techniques, the coordination complex may be co-impregnated onto the substrate before, during, and/or after solution impregnation of the other impregnants. When one or more other co-impregnants are to be impregnated onto the substrate by other, non-wet impregnation techniques such as sublimation, physical vapor deposition, chemical vapor deposition, or the like, wet impregnation of the coordination complex and other co-impregnants, if any, desirably occurs first. Representative techniques for such processing have been widely described in the literature, including the patent and literature documents cited in the Background section herein.

According to a representative solution impregnation technique for impregnating the coordination complex onto a substrate, an aqueous composition containing the coordination complex is provided. Coordination complexes of the present invention may be provided in many ways. According to one suitable approach, a first aqueous composition is prepared containing one or more amines or amine precursors offering the desired filtering efficacy. The amount of amine or amine precursor used relative to the water is not critical, although it is desired that enough water be present so that the amine, if water soluble, dissolves. If the amine or amine precursor is not fully soluble, it is desirable to use enough water so that the amine or precursor can be readily dispersed in the composition with mixing. By way of example, when forming aqueous TEDA, using about 0.5 to about 20 parts by weight of TEDA per 100 parts by weight of water would be suitable. The water may be deionized and/or distilled. In addition to the amine (and/or amine precursor) and water, the first aqueous composition may optionally further include one or more additional ingredients. For example, the solution can contain glycols such as ethylene or propylene glycol at levels up to about 25% by weight.

A second aqueous composition is also prepared by dissolving one or more sources of a transition metal in water. Transition metal salts are a convenient source for this purpose. The concentration of metal in the second compositions may vary over a wide range. However, if the concentration of the metal in the second composition is too low, then there could be insufficient transition metal present to bind with the TEDA or there will be insufficient transition metal-TEDA complex present to introduce sufficient activity for removal of the cyano-containing contaminants. On the other hand, if the concentration of the metal is too high, then the resulting solution containing the transition metal-TEDA complex could be too viscous to impregnate uniformly into the porous substrate. By way of example, when forming an aqueous solution of cobalt, copper, and/or zinc salts, using from about 1 to about 15 parts by weight of the metal salt per 100 parts by weight of water would be suitable. This generally corresponds to molar concentrations in the range of from about 0.04 mol/l to about 0.55 mol/l.

The transition metal salts typically include one or more suitable transition metals such as those described above and one or more suitable counter anions. A wide range of anions may be used. Suitable monovalent anions are preferred and include species such as acetate, carbonate, chloride, combinations of these, and the like. If chloride is used, it is desirable that the chloride not be used on the same substrate that supports a catalytically active metal such as gold. Nitrate anions may be used in some embodiments, but nitrate anions desirably are avoided in other embodiments when the nitrate material is supported upon a carbonaceous substrate due to safety concerns.

In addition to the transition metal salt and water, the second aqueous composition may optionally further include one or more additional ingredients. For example, the aqueous composition can also include colloids or dispersions of metal oxides, oxy-hydroxides, hydroxides or colloidal carbon which can be adsorbed on the surface of the support granule to increase the surface area of the external portion of the granules. Suitable metal oxides, hydroxide and oxides include those including metals such as silicon, aluminum, titanium, zirconium, iron, cobalt, nickel, manganese, copper, zinc, calcium molybdenum, tungsten and the like.

The first and second compositions are then combined with mixing to allow the amine functional ligand(s) to complex to the transition metal(s). In some embodiments, combining the first and second compositions may be accomplished by adding the first composition to the second composition dropwise. In some other embodiments, combining the first and second compositions may be accomplished by adding the second compositions to the first composition dropwise. Additionally, in some embodiments, the first and the second composition can be reacted by mixing the two solutions in a continuous process by introducing both reactants into a shared pipe or reactor at a constant rate to enable co-mingling of the reagents at the desired reactant ratio.

In some modes of practice it may be desirable to add a reagent such as hydrogen peroxide to the reaction mixture in order to oxidize a metal complex so as to form a higher oxidation state of the metal. When used, the optional peroxide may be added with mixing to one or both of the first and second compositions prior to combining and mixing the two compositions. Alternatively, the peroxide may be added while the two compositions are being combined. As another alternative, the peroxide may be added after the compositions have been combined.

A wide range of optional peroxide concentrations may be used to help to fully oxidize the metal complex to the desired oxidation state. As general guidelines, using from about 1 to about 30 parts by weight of peroxide per 100 parts by weight of total peroxide solution weight would be suitable.

The product of the reaction between the first and second compositions often will be an admixture comprising a precipitate and a supernatant. Often, the precipitate and the supernatant will be colored. The precipitate has been observed to settle quickly when excess TEDA is reacted with acetate salts of zinc, copper, and/or cobalt. In some embodiments, it has been found that the more active coordination complex product typically is in the supernatant. In such embodiments, the supernatant may be separated from the precipitate and then used to impregnate the complex onto the desired substrate. Any suitable technique may be used for this separation, including filtering, decanting, or the like.

The molar ratio of the amine to the species comprising the transition metal may vary over a wide range. By way of example, this ratio may be in the range of from about 0.1:10 to 10:0.1, more preferably 1:10 to 10:1. In one illustrative embodiment, using about 1.7 moles of TEDA per mole of a Co(II) salt was found to be suitable. When a stoichiometric excess of amine ligand is used, it is desirable to minimize the amount of the free amine that would be present on the resultant filter media. Thus, at some point after the complexation reaction is complete, the excess amine can be separated from the desired coordination complex product and then recycled or discarded. By way of example, excess TEDA can be used to prepare coordination complexes between the TEDA and a transition metal such as zinc, copper, and/or cobalt. In view of the volatility of amines such as TEDA, the excess TEDA is easily recovered during the drying of the complex-impregnated substrate(s). The free TEDA driven off the impregnated support can be trapped, such as on a cold finger or the like that may be present in the exhaust pathway of the drying apparatus. The recovered TEDA can then be used in further complexation reactions. In this fashion, the filter media is prepared with little waste of the TEDA.

In the case where the ligand is polydentate, such as in the case of the bidentate TEDA, the reaction product may involve a coordination complex in which one or more of the coordination sites of the ligand may coordinate to the transition metal. It is believed that some TEDA may coordinate to the transition metal via both coordination sites, while other TEDA coordinates via only one site. However, the coordination complex reaction product that forms when intermixing aqueous amine and/or precursor(s) thereof with aqueous transition metal salt(s) may be a mixture of complexed species in many instances. Additionally, the coordination shell of the coordination complex may incorporate other ligands in addition to the amine. Such other ligands include, for instance, water if the transition metal is hydrated to some degree. As another example, at least one unit of the anion of the metal salt might also be part of the coordination shell.

The resultant composition may be used as is. However, it has been found that the supernatant tends to contain a more active complex species than does the precipitate. Consequently, it may be desirable to use only the supernatant for solution impregnation. The supernatant and precipitate are easily separated by filtration, decanting, or the like.

The aqueous composition containing the coordination complex is then gradually added to a sample of the substrate with constant stirring. This is continued until the substrate appears to be saturated with the solution. Typically, the substrate is dry initially so that the point of saturation of the substrate is more readily observed. The wet substrate is then dried at a suitable temperature for a suitable time period. By way of example, drying the impregnated substrate at a temperature in the range of about 50° C. to about 250° C., preferably about 80° C. to about 180° C., for a time period in the range of about 1 minute to 150 hours, more preferably at least about 10 minutes to about 100 hours, would be suitable. The impregnated substrate is then cooled. Optionally, the solution impregnation, drying, and cooling may be repeated one or more times to impregnate additional amounts of the complexed amine onto the substrate. The drying period and temperature may be extended, if desired, to help ensure that any free, non-complexed amine is driven off. The excess amine that is driven off can be recovered and then recycled or discarded as desired.

In some modes of practice, an aqueous medium containing the complexed amine can also be applied to a substrate using a non-bulk contact application techniques. In the practice of the present invention, “non-bulk contact” or “non-immersive contact” means that a fluid containing the complex is caused to impregnatingly contact the substrate in a form other than via bulk absorption. Examples of non-bulk contact, or non-immersive contact, include causing the fluid containing the complex to contact the substrate as one or more streams, sprays, droplets, mist, fog, combinations of these, or the like.

In contrast to the practice of the present invention, “bulk absorption” or “immersive contact” of a fluid containing an impregnant refers to contact in which the substrate to be impregnated is caused to directly contact a liquid bath comprising the fluid. In a preferred sense, bulk absorption by a porous solid material is characterized by the penetration of a liquid into a solid, porous matrix under conditions in which the outer surface(s) of the solid are in communication with a large reservoir of liquid that has a volume in excess to the air displaced from the solid during absorption.

The non-bulk contact techniques advantageously can be used to apply the complex onto a substrate that already bears, or will be subsequently treated to bear, one or more other impregnants. This is an advantageous way to form filter systems with broad filtering capabilities because it might not always be desirable to co-impregnate the complex onto a substrate at the same time as other co-impregnants. Additionally, the filtering performance of some other impregnants, e.g., some so-called Whetlerite impregnants, might suffer if immersed in subsequent impregnation solution(s). Spraying, misting, atomizing or the like avoids subjecting Whetlerite impregnants to subsequent immersion and allows the complex to be easily impregnated onto a support separately from these and other impregnants. U.S. Pat. No. 4,801,311 describes spraying solutions containing TEDA onto substrates including whetlerite impregnants, the entirety of which is incorporated herein by reference for all purposes.

For instance, examples of a filter media comprising a combination of impregnants with broad filtering capabilities are described in U.S. Pat. Nos. 7,004,990; 6,344,071; 5,496,785; 5,344,626; 4,677,096; and 4,636,485; the respective entireties of which are incorporated herein by reference for all purposes. Complexed amine can be applied using a non-immersion technique, such as spraying, misting, atomizing, or the like onto such filter media to further enhance their respective filtering capabilities.

The amount of complexed amine incorporated into the filter media substrate may vary within a wide range. Generally, if too little is used, the CK lifetime of the resultant media may be below what is desired. Additionally, if too little complexed amine is used, a synergistic boost in filtering capabilities (e.g., organic vapor, CK, and ammonia lifetime), may not be observed when used in combination with other kinds of impregnants and/or filter media particles. On the other hand, using too much complexed amine may tend to degrade unduly the capacity of the filter media to remove organic vapors from air or other gases. Additionally, above some impregnation level, little additional benefit may be observed by the use of more amine. Balancing these concerns, the TEDA-metal complexes most desirably can be introduced onto or into the substrate at levels from 0.01 to about 25 parts by weight of the complex per about 100 parts by weight of the substrate, although higher weight impregnations can be useful. In general, because of the desire to retain a high level of adsorptivity of the high surface area supports, loadings of the amine-metal complexes in the range of from about 2 to about 10 parts by weight, more preferably about 3 to about 7 parts by weight per about 100 parts by weight of the substrate are more preferred.

The resultant filter media impregnated coordination complex and optionally one or more other co-impregnants are useful in a wide range of applications. The filtering systems are particularly suitable for primary application in personal respiratory protection to remove a broad range of toxic gases and vapors as found in industrial environments and also chemicals used as chemical warfare agents. The filtering systems successfully achieve performance levels mandated both by applicable industrial filter approval specifications and by internationally recognized military filter performance specifications. The present invention preferably relates to treatments applied to activated carbon in order to improve the ability of the activated carbon to remove low boiling point toxic gases. In preferred applications, the resultant filtering systems are used to filter breathing air in connection with personal and/or collective (e.g., building or motor vehicle) respiratory protective equipment. The broad capabilities of the filtering systems allow construction of filters which can be used in a wide variety of applications, including being fitted onto a face-mask, or being fitted singly or in multiples onto a powered air purifying respirator system. One such powered system is commercially available under the trademark “BREATHE-EASY” from the Minnesota Mining and Manufacturing Company (3M). However, the utility of the present invention is not limited to respiratory protective equipment, but also can be used for purifying air or other gases in connection with industrial processes.

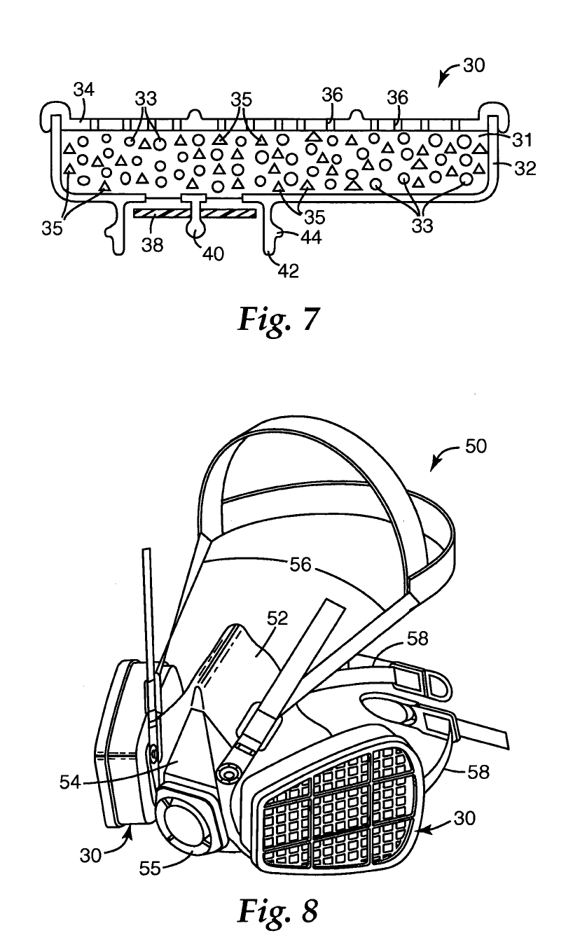

By way of example, FIGS. 7 and 8 show how the principles of the present invention may be incorporated into personal protection devices. Firstly, FIG. 7 schematically shows a schematic view, partially in cross-section, of an exemplary replaceable filter element 30 incorporating principles of the present invention. Filter element includes interior 31 that can be filled with filter media 33 containing a complexed amine impregnant and optionally one or more other impregnants and/or other additives.

Interior 31 optionally may further include one or more additional kinds of filter media. For purposes of illustration, additional filter media 35 includes a CO oxidation catalyst in the form of catalytically active gold deposited onto titania and further supported upon carbonaceous host particles as described in U.S. Ser. No. 11/275,416, filed Dec. 30, 2005, by Brady et al., titled HETEROGENEOUS, COMPOSITE, CARBONACEOUS CATALYST SYSTEM AND METHODS THAT USE CATALYTICALLY ACTIVE GOLD. Advantageously, amine in a complexed form on filter media 33 could be able to co-exist in the same filter bed with filter media 35 containing the CO oxidation catalyst without undue poisoning of the CO oxidation catalyst.

Filter media 33 and 35 are shown as being intermingled in the same filter bed in interior 31. A wide variety of other deployment strategies also may be used. As one alternative, filter media 33 and 35 may be provided in separate filter beds within interior 31 so that the incoming air passes first through one of the beds and then the other. In such embodiments, it is preferred if the filter bed incorporating the CO oxidation catalyst is downstream from the filter bed incorporating the complexed amine. This protects the catalyst from poisons in the incoming stream. Alternatively, the CO oxidation catalyst may also be upstream from the complexed amine in other embodiments. This could further minimize a risk that the complexed amine might unduly impact the CO catalyst.

The relative amounts of the filter media 33 and 35 used in interior 31 may vary over a wide range. By way of example the weight ratio of filter media 33 to filter media 35 may be in the range of from about 1:20 to 20:1, preferably 1:5 to 5:1 for granular sorbents. For other embodiments such as small particle catalysts and sorbents contained in fibrous webs, the weight ratio of filter media 33 to filter media 35 may be in the range of 1:50 to 50:1

Housing 32 and perforated cover 34 surround filter media 33 and 35. Ambient air enters filter element 30 through openings 36, passes through filter media 33 and 35 (whereupon potentially hazardous substances in the air are absorbed or otherwise treated by filter media 33 and 35), and then exits element 30 past intake valve 38 mounted on support 40.

Spigot 42 and bayonet flange 44 enable filter element 30 to be replaceably attached to a respiratory protection device such the illustrative exemplary respiratory device 50 for personal protection shown in FIG. 8. Device 50 is a so-called half mask like that shown in U.S. Pat. No. 5,062,421 and U.S. Pat. Pub. No. 2006/0096911. Device 50 includes a soft, compliant facepiece 52 that can be insert molded around a relatively thin, rigid structural member or insert 54. Insert 54 includes exhalation valve 55 and recessed, bayonet-threaded openings (not shown) for removably attaching elements 30 in the cheek regions of device 50. Adjustable headband 56 and neck straps 58 permit device 50 to be securely worn over the nose and mouth of the wearer.

The present invention will now be further described with reference to the following examples.

The reagents used in the examples include TEDA, 1,4-diazabicyclo[2.2.2.]octane (Aldrich Chemical Company, Inc. Milwaukee, Wis.) and zinc acetate, Zn(O₂CCH₃)₂.2H₂O (Merck & Company, Inc., Rahway, N.J.), cobalt acetate, Co(O₂CCH₃)₂.4H₂O (Mallinckrodt Chemical Company, New York, N.Y.), cupric acetate, Cu(O₂CCH₃)₂.H₂O (Mallinckrodt Chemical Company, New York, N.Y.), and 12×20 mesh Kuraray GG carbon (Kuraray Chemical Company Ltd., Osaka, Japan).

### Example 1

### Preparation of a Zinc-TEDA Complex—Addition of Zinc Solution to TEDA Solution

A TEDA solution was prepared by dissolving 1.54 g of TEDA in 30.0 g of deionized water. While mixing this solution rapidly using a high shear mixer (IKA Ultra Turrax T18 mixer; IKA Works, Inc., Wilmington, Del.), a solution of zinc acetate (0.76 g of Zn(O₂CCH₃)₂.2H₂O dissolved in 30.0 g of deionized water) was added dropwise. The mixture formed a cloudy white solid during this addition.

### Example 2

### Preparation of a Zinc-TEDA Complex—Addition of TEDA Solution to Zinc Solution

A solution of zinc acetate was prepared by dissolving 0.76 g of Zn(O₂CCH₃)₂.2H₂O in 30.0 g of deionized water. A TEDA solution was prepared by dissolving 1.54 g of TEDA in 30.0 g of deionized water. While mixing the zinc acetate solution rapidly using a high shear mixer (IKA Ultra Turrax T18 mixer; IKA Works, Inc., Wilmington, Del.), the TEDA solution was added dropwise to said zinc acetate solution. The mixture formed a cloudy white solid during this addition.

### Example 3

### Preparation of a Cobalt-TEDA Complex—Addition of Cobalt Solution to TEDA Solution

A solution of cobalt acetate was prepared by dissolving 0.57 g of Co(O₂CCH₃)₂.4H₂O in 30.0 g of deionized water. This solution was added dropwise with rapid stirring using a high shear mixer ((IKA Ultra Turrax T18 mixer; IKA Works, Inc., Wilmington, Del.) to a solution of 1.54 g of TEDA dissolved in 30.0 g of deionized water. The solution turned a light blue and progressed to a greenish turquoise during this addition. While continuing to stir this mixture, 8 drops of 30% H₂O₂ was added. The solution turned to a dark brown upon addition of the hydrogen peroxide and the solution appeared to not have a precipitate.

### Example 4

### Preparation of Cobalt-TEDA Complex—Addition of TEDA Solution to Cobalt Solution

An aqueous solution of TEDA was prepared by dissolving 1.54 g of TEDA in 30.0 g of deionized water. An aqueous solution of cobalt acetate was prepared by dissolving 0.57 g of Co(O₂CCH₃)₂.4H₂O in 30.0 g of deionized water. The TEDA solution was added dropwise with rapid stirring to the cobalt acetate solution using a high shear mixer ((IKA Ultra Turrax T18 mixer; IKA Works, Inc., Wilmington, Del.). The color changes observed during this addition appeared similar to that observed in example 3. While continuing to stir this mixture, 8 drops of 30% H₂O₂ was added. The solution turned to a dark brown upon addition of the hydrogen peroxide. The mixture comprised a dark solid that settled upon cessation of the mixing along with a light brown solution.

### Examples 5-8

### Supporting Metal-TEDA Complexes on Carbon

The solutions formed in examples 1-4 were impregnated into carbon particles in the following manner. The solutions formed in examples 1-4 were added dropwise with constant stirring to samples of 12×20 mesh Kuraray GG carbon (Kuraray Chemical Company Ltd, Osaka, Japan); 53 g of Kuraray GG carbon for examples 5 and 6 which use solutions from examples 1 and 2 respectively and 50 g of Kuraray carbon for examples 7 and 8 which use solutions from examples 3 and 4 respectively) until the carbon appeared to be saturated (about ½ of the solution). The treated carbon was then placed into an oven at 110° C. and dried for about 20 minutes. The treated carbon was then removed, allowed to cool, and the remainder of the metal-TEDA complex solution was added. Again, the treated carbon was again placed into the oven and dried. The treated carbons were finally dried at 130° C. for 72 hours.

### Test Procedure 1: ClCN Challenge Testing of 5 mL of Granular Activated Carbon Sorbent (Tube Test)

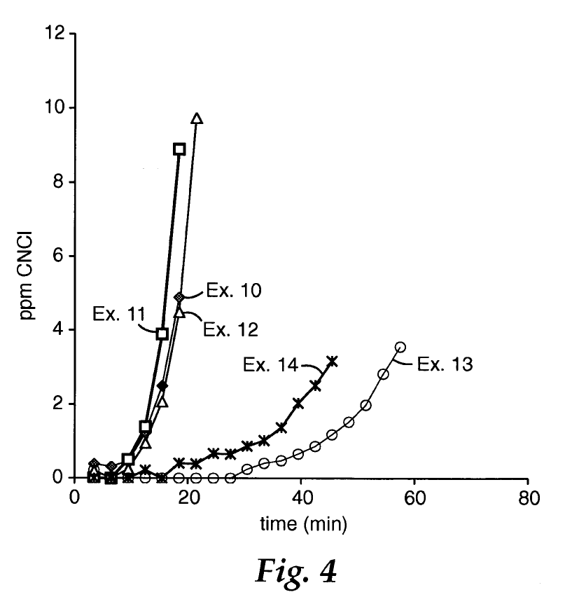

FIG. 4 of Assignee's co-pending U.S. Provisional Application Ser. No. 60/777,859, filed Feb. 28, 2006, by Thomas I. Insley, titled LOW PRESSURE DROP, HIGHLY ACTIVE CATALYST SYSTEMS USING CATALYTICALLY ACTIVE GOLD shows a test system used to subject activated carbon sorbent samples to CO challenges in order to assess their performance for oxidizing the CO from air. A similar system was used herein to subject samples to ClCN challenges in order to assess their performance for removing ClCN from air. Flow rates, GC column parameters, and calibration suitable for cyanogen chloride analysis were used as described below. As an overview of the procedure, high-pressure compressed air is reduced in pressure, regulated, and filtered by a regulator (3M Model W-2806 Air Filtration and Regulation Panel, 3M, St. Paul, Minn.) to remove particulates and oils. A valve (Hoke Inc., Spartanburg, S.C.) is used to set the desired main airflow rate as measured by a flow meter (Dwyer Instruments, Michigan City, Ind.) with a range of 0 to 200 SCFH. The flow meter was calibrated using a dry gas test meter (American Meter, model DTM-325; not shown).

The main airflow passes through the headspace above a heated distilled water bath and then into a 250 ml mixing flask. Relative humidity in the mixing flask is monitored using a RH sensor (Type 850-252, General Eastern, Wilmington, Mass.). The RH sensor provides an electrical signal to a humidity controller (a PID controller series CN1201AT from Omega Engineering, Stamford, Conn.) that delivers power to a submerged heater to maintain the RH at the set point. Unless otherwise indicated, the relative humidity is controlled at 92%.

High purity cyanogen chloride was prepared using the method described by H. Schröder in Z. anor. allg. Chem. 297, 296 (1958) and stored in a steel lecture bottle. The method relies upon the following reaction scheme:

K₂[Zn(CN)₄]+4Cl₂=>4ClCN+2KCl+ZnCl₂

Sodium pyrophosphate at 5% of the ClCN weight was added as a stabilizer. The lecture bottle of cyanogen chloride provides a flow of ClCN vapor.

An Aalborg 150 mm PTFE-glass rotameter with flowtube 042-15-GL is used to measure ClCN volumetric flow. A stainless steel, fine metering valve (Whitey Co. SS21RS4, Highland Heights, Ohio) is used to set the desired ClCN flow rate.

The combined ClCN/air mixture at a concentration of 550 ppm ClCN at 32 L/min and 92% RH then flows into a polycarbonate box equipped with 29/42 connections at the top and bottom. A portion of this flow (1.6 L/min) is pulled through a fixture containing the activated carbon adsorbent while the excess is vented outside the box.

An activated carbon sorbent sample is loaded into a fixture including a ⅝ inch ID (¾ inch OD) copper tube about 3.5 inches in length sealed at one end by a cotton plug and mated at this end to a 29/42 outer fitting. A volume of 5 mL is measured by loading it into a graduated cylinder using the method described in ASTM D2854-96 Standard Method for Apparent Density of Activated Carbon. The 5 mL sample is then loaded into the fixture using the same method.

The fixture containing the activated carbon sorbent is mounted on the 29/42 inner fitting at the bottom of the polycarbonate box. The base of the 29/42 fitting is threaded and engages through a 90° elbow connector to a ½ inch OD tube connected to a vacuum source through a rotameter and needle valve. The tube also connects to a vacuum source which draws sample to the sampling valve of the GC. The small flow to the GC (approximately 50 mL/min) is negligible in comparison to the total flow through the carbon bed. The rotameter is calibrated by placing a Gilibrator soap bubble flow meter at the entrance to the fixture containing the carbon bed.

To start the test, a steady 32 L/min flow of a ClCN/air mixture at 550 ppm and 92% RH is introduced into the polycarbonate box. The needle valve is then adjusted to give a flow of 1.6 L/min through the activated carbon bed.

ClCN concentration exiting the sorbent bed is measured with a SRI 8610C gas chromatograph (SRI Instruments, Torrance, Calif.) equipped with a gas sampling valve and a hydrogen flame ionization detector. A vacuum source continuously draws approximately 50 mL/min of sample from the test outlet through the gas sampling valve of the GC. Periodically the valve injects a sample onto a 6 ft×⅛ inch column of 10% Carbowax 20M on Chromosorb W-HP 80/100 (Alltech part 12106PC, Alltech Associates, Deerfield, Ill.). ClCN is separated from air and its concentration measured by a hydrogen flame ionization detector (minimum detectable ClCN concentration about 0.5 ppm. The GC is calibrated using ClCN in air mixtures prepared by injecting known volumes of ClCN vapor into a 39.2 L stainless steel tank filled with air. An internal fan circulates the mixture inside the tank. The vacuum source draws a sample of the mixture into the gas sampling valve of the GC for analysis. Calibration of the FID was linear over the entire range from 0.5 to 600 ppm ClCN.

Each ClCN analysis takes about 3 minutes. After completion of the analysis, another sample is injected onto the column and the analysis repeated.

### Testing of Samples from Examples 5-8 for Activity in the Removal of Cyanogen Chloride from a Gas Stream

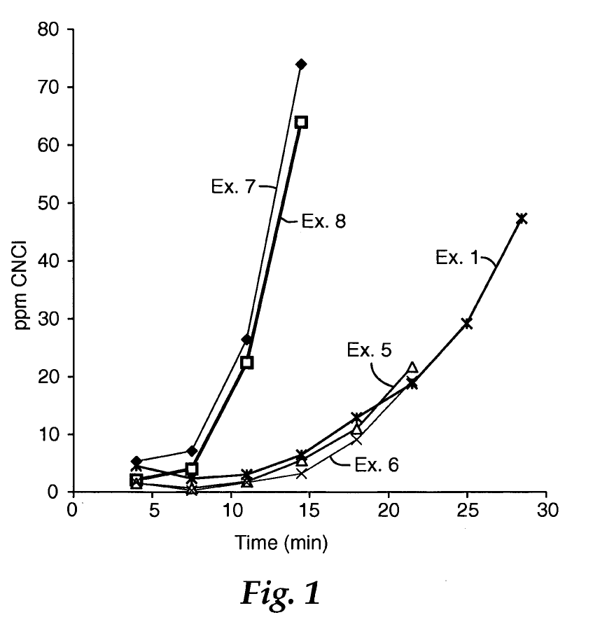

Samples prepared as described in examples 5-8 were tested for their ability to remove cyanogen chloride from a gas stream as described above in test procedure 1. The results are shown in FIG. 1. The sample labeled “Example 1—TEDA/Zn(Oac)2” corresponds to a additional sample prepared according to example 1. As can be seen from this test, the metal-TEDA complexes efficiently removed the ClCN from the gas stream with the samples containing zinc being very effective in removing ClCN with breakthrough times in this test being greater than 15 minutes and with the breakthrough being characterized by a very slow increase of the ClCN coming through the test fixture.

### Example 9 and Comparative Examples 1 Through 3

### Effect of Thermal Aging of the Metal-TEDA Complexes in the Presence of an Active Nano-gold CO Oxidation Catalyst—Effect of Metal-TEDA Complex on the Activity of the Nano-Gold Catalyst

### Comparative Example 1

A sample of Kuraray GG carbon was used in its untreated or unaltered form.

### Comparative Example 2

A sample of Calgon ASZM-TEDA, an activated carbon containing copper, zinc, silver and molybdenum compounds as well as 3 weight % TEDA was used in its untreated or unaltered form. This is a commercial TEDA-containing carbon for use in military filtration. It is effective at removing cyanogen chloride from gas streams. This sample was a good sorbent for removing cyanogen chloride (CK). However, when placed into the same system with a gold catalyst and aged at, e.g., 71° C. for 168 hours, the sample damaged the gold catalyst.

### Comparative Example 3

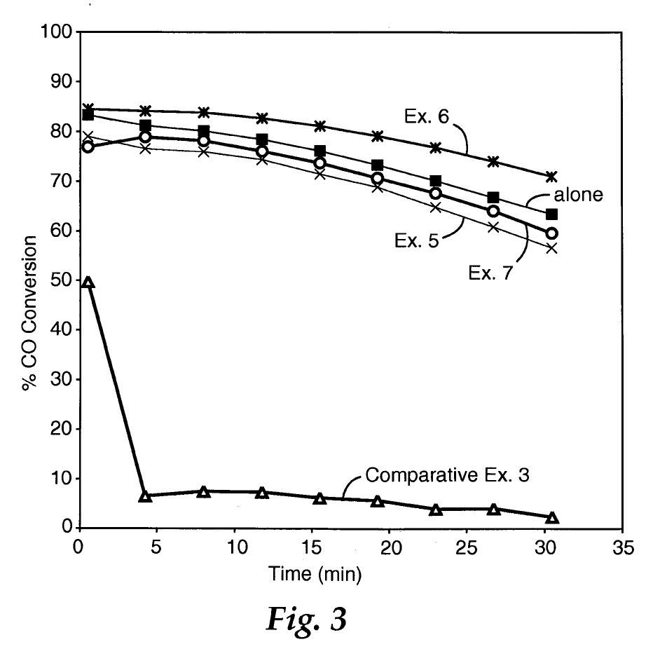

URC-TEDA is another TEDA-treated carbon included for comparison. This material is made by depositing TEDA on an activated carbon that contains copper, ammonium sulfate, and ammonium dimolybdate. Data relating to the effect of this sample on the CO oxidation activity of the nano-gold catalyst after aging in the catalyst in the presence of the sample in a closed vessel at 71° C. for 168 hours is shown in FIG. 3.

### Example 9

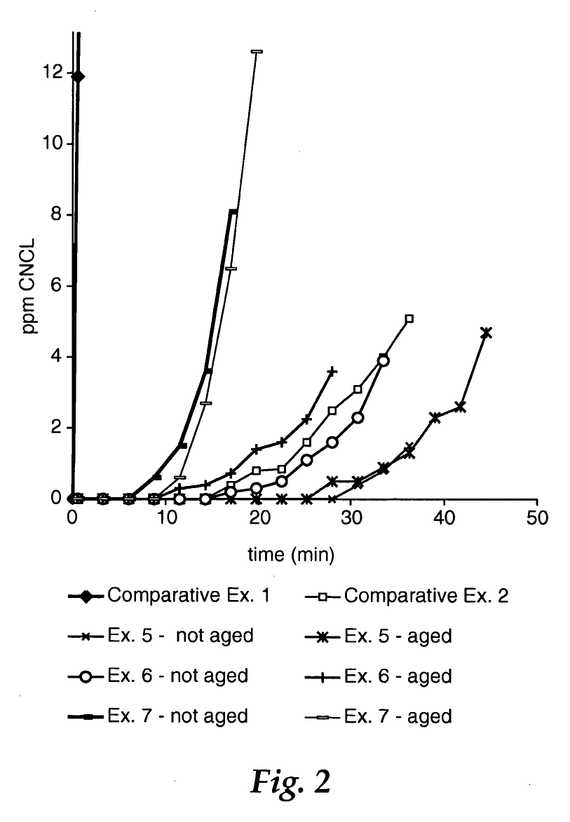

Samples of the materials of examples 5-7 were thermally aged in the presence of a nanogold CO oxidation catalyst to determine the effect of this aging on both the catalytic activity of the CO oxidation catalyst and the effect of the thermal aging on the activity of the metal-TEDA complex to remove cyanogen chloride. To do this test, 25 mL of the TEDA-metal treated carbons from each of examples 5-7 were placed individually in 4 ounce jars. A 6 mL sample of a CO oxidation catalyst incorporating catalytically active gold was placed in a 20 mL vial and one of these vials containing the catalyst sample was placed without a lid into each of the 4 ounce jars containing the TEDA-metal treated carbon samples. The CO catalyst was gold on Hombikat UV100 titania on Kuraray GG carbon and made according to U.S. Ser. No. 11/275,416, filed Dec. 30, 2005, by Brady et al., titled HETEROGENEOUS, COMPOSITE, CARBONACEOUS CATALYST SYSTEM AND METHODS THAT USE CATALYTICALLY ACTIVE GOLD. Each of the jars containing both the 20 mL vials with the standard catalyst samples and the 25 mL of the TEDA-metal treated carbons were each sealed with a lid and placed in an oven held at 71° C. for 168 hours. This allowed any vapors produced by the TEDA-metal treated carbons to interact with the standard catalyst samples during the aging time. After this time the samples were cooled and the jars were opened and the individual samples were removed for testing. The results of the testing are displayed graphically in FIG. 2. Along with the results of testing the thermally aged samples, the graph also shows an additional testing of the parent samples that had not been treated thermally for 168 hours for comparison. As can be seen, the untreated sample of Kuraray GG carbon exhibited no protection against the challenge of the cyanogen chloride. The samples of the metal-TEDA materials of the present invention showed high activity for removal of the cyanogen chloride and essentially no change in activity after being thermally aged.

In order to determine the effect on the CO oxidation catalyst caused by aging the CO catalyst in the presence of each of samples containing TEDA, after such aging, the activity of the catalyst was measured by its ability to catalyze the oxidation of CO over a time period of about 30 minutes. In this test, a 3600 ppm CO challenge was used along with a flow rate was 9.6 liters per minutes, the relative humidity was >90%, and the sample size in each case was 5 mL of catalyst. The results of this test are displayed in FIG. 3. A catalyst sample that has been aged without exposure to any of the TEDA-containing samples is marked “un-aged reference catalyst sample” in the legend. Using the performance of this material as a reference, it is clearly seen that exposing the catalyst to the URC-TEDA sample for 168 hours at 71° C. causes severe degradation of the catalyst performance. The unexposed reference sample began by exhibiting greater than 80% removal of the CO by oxidation of the CO that was passed through the catalyst bed. The sample aged in the presence of the URC-TEDA exhibited lower than 10% conversion at the beginning of the test. Thus, exposure of the catalyst to the URC-TEDA in this thermal aging test resulted in a greater than 88% decrease in catalyst performance. In sharp contrast to this, the metal-TEDA samples showed little affect on the catalyst performance and in one case actually increased the catalyst performance.

### Examples 10-14

### Effect of Method of Addition of the Metal-TEDA Complex to Carbon and Use of Metal-TEDA Complexes in Carbon Containing Zinc Acetate

A zinc-TEDA complex was prepared by the addition of a solution of 2.53 g of zinc acetate dihydrate in 100.0 g deionized water to a solution of 5.13 g of TEDA dissolved in 100.0 g deionized water with rapid stirring. This solution is designated solution 1. A second zinc-TEDA complex was prepared by the addition of a solution of 5.13 g of TEDA dissolved in 100.0 g deionized water to a solution of 2.53 g of zinc acetate dihydrate in 100.0 g deionized water with rapid stirring. This is designated solution 2.

### Example 10

A 50 g sample of Kuraray GG carbon was impregnated with 30.0 g of solution 2 and the impregnated carbon sample was placed on a glass tray and dried at 110° C. in an oven for 14 hours.

### Example 11

A 50 g sample of Kuraray GG carbon was impregnated with 20.0 g of solution 2 and the impregnated carbon sample was placed on a glass tray and dried at 110° C. in an oven for 2 hours. The dried sample was removed from the oven, cooled and the impregnated again with a 10.0 g sample of solution 2. This impregnated carbon was placed again on a glass tray and dried at 110° C. for about 12 hours.

### Example 12

A 50 g sample of Kuraray GG carbon was impregnated with 30.0 g of solution 1 and the impregnated carbon sample was placed on a glass tray and dried at 110° C. in an oven for 2 hours. The dried sample was removed from the oven, cooled and the impregnated again with a 30.0 g sample of solution 1. This impregnated carbon was placed again on a glass tray and dried at 110° C. for about 12 hours.

### Example 13

A 50 g sample of Carbon B (an activated carbon impregnated sequentially with zinc acetate and potassium carbonate then dried) was impregnated with 30.0 g of solution 1 and the impregnated carbon sample was placed on a glass tray and dried at 110° C. in an oven for 2 hours. The dried sample was removed from the oven, cooled and then impregnated again with a 30.0 g sample of solution 1. This impregnated carbon was placed again on a glass tray and dried at 110° C. for about 12 hours.

### Example 14

A 50 g sample of Carbon B (an activated carbon impregnated sequentially with potassium carbonate and zinc acetate then dried) was impregnated with 15.0 g of solution 1 and the impregnated carbon sample was placed on a glass tray and dried at 110° C. in an oven for 2 hours. The dried sample was removed from the oven, cooled and the impregnated again with a 15.0 g sample of solution 1. This impregnated carbon was placed again on a glass tray and dried at 110° C. for about 12 hours.

### Testing of the Capability of the Samples Made in Examples 10-14

The performance of the materials prepared as described in examples 10-14 was tested using Test Procedure 1. The results of this testing are graphically shown in FIG. 4. All the samples containing the metal-TEDA complexes performed well in this test. Impregnation of the metal-TEDA complex into the Carbon B that contained zinc prior to this impregnation resulted in a much more active cyanogen chloride removal agent. In this case example 14 contained only half as much of the zinc-TEDA complex as example 12, but the performance was far superior. It is believed that excess TEDA in solution 1 reacted with uncomplexed zinc in the Carbon B resulting in additional zinc-TEDA complex with the net result of greater activity.

### Example 15-20

### Effect of Using Different Portions of the Metal-TEDA Complex Mixture

These experiments were performed to determine if the most active portion of the metal-TEDA complex mixture is in the solid that is formed or if it is dissolved as a soluble metal complex in the liquid.

### Preparation of Impregnation Solution for Examples 15-20

A solution of zinc acetate was prepared by dissolving 2.53 g of Zn(O₂CCH₃)₂.2H₂O in 100.0 g of deionized water was added dropwise with rapid stirring to a solution of 5.13 g of TEDA in 100.0 g of deionized water. The solution was aged for 48 hours prior to use. The solution was filtered to yield a white solid. The filtrate solution was labeled “filtered.” The volume of the filtrate solution was measured and the white solid was redispersed in that volume of deionized water. This dispersed solid sol is labeled “redispersed.”

### Example 15

A 50 g sample of Kuraray GG carbon was impregnated with 37.17 g of the filtered solution by adding the solution dropwise to the carbon with constant stirring with a spatula until saturated. The impregnated granules were dried at 110° C. overnight and placed in a sealed jar for testing. The treated granules were tested according to procedure 1.

### Example 16

A 50 g sample of Kuraray GG carbon was impregnated with 35.9 g of the redispersed sol by adding the sol dropwise to the carbon with constant stirring with a spatula until saturated. The impregnated granules were dried at 110° C. overnight and placed in a sealed jar for testing. The treated granules were tested according to procedure 1.

### Example 17

A 50 g sample of Kuraray GG carbon was impregnated with 37.23 g of the filtered solution by adding the solution dropwise to the carbon with constant stirring with a spatula until saturated. The impregnated granules were dried at 110° C. for about 2 hours and then cooled and impregnated in the same manner with 36.56 g of the redispersed solution. The impregnated granules were dried at 110° C. overnight and placed in a sealed jar for testing. The treated granules were tested according to procedure 1.

### Example 18

A 50 g sample of Carbon B was impregnated with 25.67 g of the filtered solution by adding the solution dropwise to the carbon with constant stirring with a spatula until saturated. The impregnated granules were dried at 110° C. overnight and placed in a sealed jar for testing. The treated granules were tested according to procedure 1.

### Example 19

A 50 g sample of Carbon B was impregnated with 25.60 g of the redispersed sol by adding the sol dropwise to the carbon with constant stirring with a spatula until saturated. The impregnated granules were dried at 110° C. overnight and placed in a sealed jar for testing. The treated granules were tested according to procedure 1.

### Example 20

A 50 g sample of Carbon B was impregnated with 25.63 g of the filtered solution by adding the solution dropwise to the carbon with constant stirring with a spatula until saturated. The impregnated granules were dried at 110° C. for about 2 hours and then cooled and impregnated in the same manner with 25.60 g of the redispersed solution. The impregnated granules were dried at 110° C. overnight and placed in a sealed jar for testing. The treated granules were tested according to procedure 1.

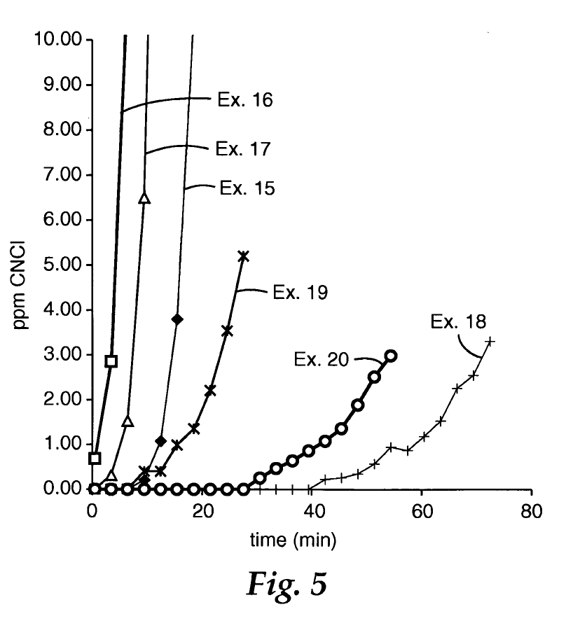

The results of the testing of materials of examples 15-20 are graphically displayed in FIG. 5. As is clearly seen from the graph, the filtered solution possessed the greatest cyanogen destroying capability. Interestingly, impregnating with both the solution and the redispersed sol actually resulted in less activity and shorter breakthrough times. It may be possible that the solid material that carries little activity, when applied over an impregnation of the filtered solution, blocks the active agent that is found in the solution resulting in lower activity.

### Examples 21-24

### Synthesis and Use of Copper-TEDA Complexes

### Example 21

A solution of copper acetate was prepared by dissolving 2.28 g of Cu(O₂CCH₃)₂.H₂O in 100 g of deionized water. A solution of TEDA was prepared by dissolving 5.13 g of TEDA in 100 g of deionized water. The TEDA-copper complex was prepared by adding the copper solution to the TEDA solution with rapid stirring. The mixture quickly turned dark brown after this addition. This solution, called TEDA-Cu solution 1, was used to prepare the samples of examples 21-24.

A 50 g sample of Kuraray GG carbon was impregnated with 20.0 g of the TEDA-Cu solution 1 while stirring the carbon granules with a spatula. After this addition the impregnated carbon granules were dried in an oven overnight at 110° C.

### Example 22

A 50 g sample of Carbon B was impregnated with 26.9 g of the TEDA-Cu solution 1 while stirring the carbon granules with a spatula. After this addition the impregnated carbon granules were dried in an oven overnight at 110° C.

### Example 23

A 50 g sample of Kuraray GG carbon was impregnated with 20.0 g of the TEDA-Cu solution 1 while stirring the carbon granules with a spatula. After this addition the impregnated carbon granules were dried in an oven for 2 hours at 110° C. After drying, the sample was removed from the oven, cooled and an additional 20.0 g portion of TEDA-Cu solution 1 was impregnated into the granules by adding the solution to the granules slowly dropwise while stirring the granules with a spatula. After this addition the twice impregnated carbon granules were dried in an oven overnight at 110° C.

### Example 24

A 50 g sample of Carbon B was impregnated with 13.5 g of the TEDA-Cu solution 1 while stirring the carbon granules with a spatula. After this addition the impregnated carbon granules were dried in an oven for 2 hours at 110° C. After drying, the sample was removed from the oven, cooled and an additional 13.5 g portion of TEDA-Cu solution 1 was impregnated into the granules by adding the solution to the granules slowly dropwise while stirring the granules with a spatula. After this addition the twice impregnated carbon granules were dried in an oven overnight at 110° C.

### Comparative Example 4

A sample of untreated Carbon B particles was examined for comparative purposes to determine if these materials had any capability to remove cyanogen chloride without further treatment.

### Test Results of Examples 21-24 and Comparative Example 4

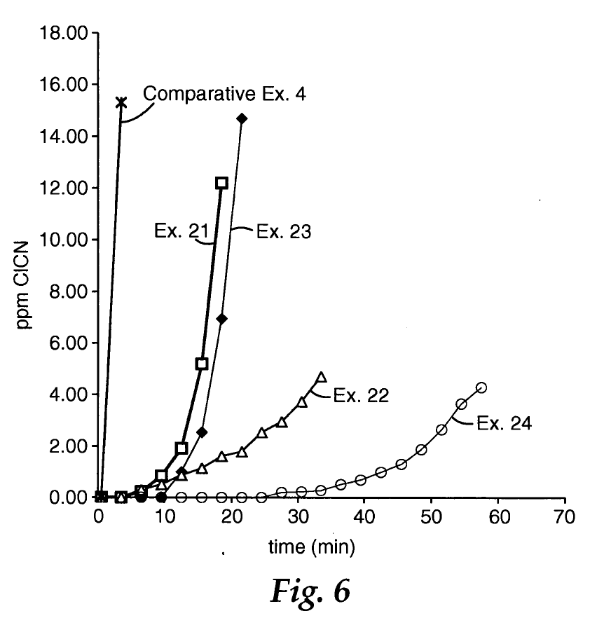

As seen in FIG. 6, the TEDA-copper complexes possessed high cyanogen chloride removal activity as reflected by the long exposure times before the level of cyanogen chloride increased. On the other hand, the untreated Carbon B, comparative example 4, showed essentially no activity in removing cyanogen chloride from the gas stream. This shows that it is in fact the addition of the copper-TEDA mixture that produces the high activity that is noted. In this case impregnating the Carbon B two times with half the volume of the TEDA-Cu solution 1 produced a much more active cyanogen chloride removal agent than impregnating the Carbon B with the full volume in one impregnation step. In addition, the carbon containing the additionally impregnated base, Carbon B, was a much more active cyanogen chloride removal agent than the carbon that had not been additionally impregnated with base.

### Examples 25-26

### Effect of Moisture Content When Aging CO Oxidation Catalyst in the Presence of TEDA-Zinc Complex

### Example 25

A TEDA solution (Solution A) was prepared by dissolving 7.5 g of TEDA in 92.6 g of deionized water. A zinc acetate solution (Solution B) was prepared by dissolving 3.7 g of zinc acetate dehydrate in 94.4 g of deionized water. A TEDA-zinc complex solution was prepared by adding solution B to Solution A while rapidly stirring. A 100 g sample of 12×20 mesh Kuraray GG carbon was impregnated with 80 g of the resulting TEDA-zinc complex solution by adding the solution dropwise to the Kuraray GG carbon while constantly stirring the carbon particles. The resulting TEDA-zinc complex-impregnated sample was placed in the oven at 100° C.

### Example 26

After a period of time, a sample of the drying TEDA-zinc complex from Example 25 was removed from the drying bed of impregnated carbon. This sample was divided into two parts. The moisture content one of these parts was found by measuring the weight loss caused by heating this part of this sample at 105° C. for 6 hours. The second part of the sample was tested as to how the sample would affect the catalyst activity as was previously described for example 9 and comparative examples 1 through 3 with the exception that after the aging (168 hours, 71° C.), the CO catalyst test was altered in the following ways: the flow rate was increased to 64 liters per minute and the sample size was 15 ml and the sample volume was increased prior to this test by the addition of 10 ml of inert material (Kurray GG carbon). The catalyst activity is indicated by the percent CO removal of the challenge gas after 23 minutes of the test.

### Example 27

After an additional period of time, a sample of the drying TEDA-zinc complex from Example 25 was removed from the drying bed of impregnated carbon and tested as described in example 26.

### Comparative Example 5

A sample of the CO reference catalyst used in examples 26 and 27 was tested after aging (168 hours, 71° C.) but without the presence of any TEDA-containing carbons. The catalytic activity after aging was found to be 70.2%.

### Test Results of Examples 26 and 27 and Comparative Example 5

The moisture content of this example 26 was measured to be 4.37 weight percent and the catalyst activity was found to be 32.8%. After the additional drying (example 27) the moisture content was measured to be 1.55 weight percent and the catalyst activity was found to be 61.6%. As can be seen by the lower loss of catalytic activity for the case where the reference CO oxidation catalyst is aged with the more well-dried sample, removal of water by drying is important to maintain high catalytic activity when CO oxidation catalysts are aged in the presence of the materials of the present invention.

Other embodiments of this invention will be apparent to those skilled in the art upon consideration of this specification or from practice of the invention disclosed herein. Various omissions, modifications, and changes to the principles and embodiments described herein may be made by one skilled in the art without departing from the true scope and spirit of the invention which is indicated by the following claims.

1. A method of forming a filter medium, comprising the steps of:
(a) providing a reaction product of an amine functional material and a species comprising a transition metal;
(b) causing at least one base to contact a substrate; and
(c) after contacting the substrate with the at least one base, impregnating the reaction product onto the substrate.

2. The method of claim 1, wherein the step (a) comprises combining an aqueous amine with an aqueous salt of the transition metal.

3. The method of claim 1, wherein the amine functional material comprises TEDA.

4. The method of claim 1, wherein the species comprising the transition metal is introduced as a salt of the transition metal.

5. The method of claim 1, wherein the transition metal is selected from Co, Zn, and Cu.

6. The method of claim 3, wherein the transition metal is selected from Co, Zn, and Cu.

7. The method of claim 1, wherein the reaction product comprises a coordination complex having a coordination shell, said coordination shell comprising the amine functional material.

8. The method of claim 2, wherein the aqueous amine is in stoichiometric excess with respect to the aqueous transition metal with respect to forming a coordination complex between the amine and the transition metal.

9. The method of claim 8, further comprising the steps of:
thermally treating the impregnated substrate;
recovering amine driven off the substrate during the thermal treating; and
recycling at least a portion of the recovered amine.

10. The method of claim 1, wherein the base is selected from KOH and a carbonate salt.

11. The method of claim 1, wherein the base comprises KOH.

12. The method of claim 1, wherein the base comprises a carbonate.

13. The method of claim 1, wherein the base comprises potassium carbonate.

14. The method of claim 1, further comprising the steps of causing the filter medium to be in a filter system that includes at least one additional filter medium and causing the filter system to include less than about 2 parts by weight of water per 100 parts by weight of the filter media.

15. The method of claim 14, wherein the at least one additional filter medium includes a catalyst.

16. The method of claim 15, wherein the catalyst comprises gold.

17. A method of filtering, comprising using a filter medium made in accordance with any of claims 1-16 to filter a fluid stream.

18. The method of claim 17, wherein the filter medium is in with a filter system that includes at least one additional filter medium.

19. The method of claim 17, wherein the filter medium is upstream from the at least one additional filter medium.

20. The method of claim 17, wherein the filter medium is downstream from the at least one additional filter medium.

21. The method of claim 18, wherein an additional filter medium includes a catalyst.

22. The method of claim 21, wherein the catalyst includes gold.

23. A filter system, comprising:
(a) a first filter medium comprising an impregnant derived from ingredients comprising an amine complex; and
(b) a second filter medium comprising a catalyst.

24. The filter system of claim 23, wherein the amine complex is supported upon a carbonaceous substrate.

25. The filter system of claim 23, wherein the amine complex is derived from ingredients comprising TEDA and a salt of a transition metal.

26. The filter system of claim 25, wherein the transition metal is Co.

27. The filter system of claim 25, wherein the transition metal is Cu.

28. The filter system of claim 25, wherein the transition metal is Zn.

29. The filter system of claim 23, wherein the catalyst comprises gold.

30. The filter system of claim 23, wherein the system comprises less than about 2 parts by weight of water per 100 parts by weight of the first and second filter media.

31. The filter system of claim 23, wherein the system comprises less than about 1 part by weight of water per 100 parts by weight of the first and second filter media.

32. The filter system of claim 23, wherein an impregnant derived from the amine complex is supported upon a first particulate substrate and wherein the catalyst is supported upon a second particulate substrate.

33. The filter system of claim 23, wherein the first filter medium further comprises an impregnant derived from a base.

34. The filter system of claim 33, wherein the base is selected from KOH and a carbonate.

35. The filter system of claim 34, wherein the base is KOH.

36. The filter system of claim 34, wherein the base is a carbonate.

37. The filter system of claim 34, wherein the base is potassium carbonate.

38. The filter system of claim 23, wherein at least one of the first and second filter media further includes an impregnant having a filtering efficacy against an acid gas.

39. The filter system of claim 23 or claim 38, wherein at least one of the first and second filter media further includes an impregnant having a filtering efficacy against ammonia.

40. The filter system of claim 23, 38, or 39, wherein the catalyst helps to catalyze the oxidation of CO.

41. The filter system of claim 40, wherein the catalyst comprises gold.

42. The filter system of claim 23, wherein the filter system is incorporated into a collective respiratory protection system.

43. The filter system of claim 23, wherein the filter system is incorporated into a personal respiratory protection system.

44. The filter system of claim 23, wherein the system is a constituent of a filter element.

45. The filter system of claim 23, wherein the system is a constituent of a respiratory protection device.

46. A method of making a filter medium, which method comprises the steps of:
a) incorporating at least one impregnant onto a supporting substrate;
b) after step (a), using a non-bulk contact technique to apply an amine complex onto the supporting substrate.
